(19) United States
(12) Patent Application Publication
(10) Pub. No.: US 2016/0101476 A1
(43) Pub. Date: Apr. 14, 2016

(54) CUTTING APPARATUS AND CUTTING METHOD

(71) Applicant: TOYOTA JIDOSHA KABUSHIKI KAISHA, Aichi (JP)

(72) Inventors: Junji YAMAUCHI, Toyota-shi (JP); Kazumi SAITO, Toyota-shi (JP); Masaki TANZAWA, Toyota-shi (JP); Tetsuji EGAWA, Toyota-shi (JP)

(73) Assignee: TOYOTA JIDOSHA KABUSHIKI KAISHA, Toyota-shi (JP)

(21) Appl. No.: 14/892,725

(22) PCT Filed: May 22, 2013
(86) PCT No.: PCT/JP2013/064256

§ 371 Date: Nov. 20, 2015

(51) Int. Cl. B23D 33/08; B23D 27/00

(52) U.S. Cl. CPC B23D 33/08; B23D 27/00

(57) ABSTRACT

A cutting device for cutting a flat workpiece includes a nibbler that continuously punches the workpiece, and a fluid spraying device that sprays a fluid onto the surface of the workpiece. The nibbler includes a cylindrical case, a punch that has a punch blade for punching the workpiece and that is accommodated in the case to have reciprocating motion in the vertical direction, and a die provided below the case. The cutting device is configured to move the workpiece interposed between the case and die in a prescribed direction while continuously punching the workpiece with the punch. The fluid spraying device has a spray port from which the fluid is discharged and is configured so the fluid is discharged from the spray port in the direction in which the punch approaches the die. The spray port of the fluid spraying device is disposed near the punch blade of the punch.

### TECHNICAL FIELD

The present invention relates to a cutting apparatus and cutting method for cutting a sheet-like workpiece.

### BACKGROUND ART

Conventionally, a nibbler is widely known as a device for cutting a sheet-like workpiece (for example, a steel sheet) (for example, see JP 9-234622 A).

Generally, the nibbler includes a cylindrical case, a punch arranged in the case, which reciprocates in a top-bottom direction, and a die arranged below the case. The nibbler cuts the workpiece by punching the workpiece continuously with the punch, while moving in a prescribed direction with the sheet-like workpiece interposed between the case and the die.

In the nibbler configured as described above, the workpiece comes in contact with the side of the punch after punting the workpiece with the punch.

Therefore, a part of the workpiece coming in contact with the punch is lifted up according to the punch rising, and falls by elastic force of the workpiece. That is, the workpiece is intermittently lifted up according to the reciprocating motion of the punch, and is vibrated.

If the workpiece is vibrated, the position of the part of the workpiece being cut is not stabilized. Therefore, it is difficult to cut the workpiece with the nibbler with high precision.

Further, the part of the workpiece lifted up by the punch falls and crashes against the die, so that the undesirable noise occurs in the work environment.

A means for solving the above problems includes fixing the workpiece.

However, an unwanted part of the workpiece falls under its own weight after removed by the nibbler, so that it is difficult to fix the unwanted part. A complicated mechanism of the apparatus is required to fix the unwanted part of the workpiece, so that it is disadvantageous in that cost for cutting the workpiece is increased.

Further, the means for solving the above problems includes reducing the distance between the case and the die in the nibbler. The workpiece is fixed between the case and the die by reducing the distance between the case and the die to a value substantially equal to the thickness of the workpiece, which prevents the workpiece from being lifted up by the punch.

However, when the workpiece is cut by the nibbler, the case and the die interfere with the workpiece, so that it is disadvantageous in that the shape of the workpiece cut by the nibbler is restricted.

### CITATION LIST

### Patent Literature

PTL1: JP 9-234622 A

### SUMMARY OF INVENTION

### Technical Problem

The object of the present invention is to suppress vibration of the workpiece at low cost and to cut a workpiece with high precision.

### Solution to Problem

A first aspect of the invention is a cutting apparatus for cutting a sheet-like workpiece including a nibbler that continuously punches the workpiece, at least one fluid jetting device that jets a fluid onto a surface of the workpiece. The nibbler includes a cylindrical case, a punch that has a blade for punching the workpiece and that is housed in the case to reciprocate in a top-bottom direction, and a die provided below the case, and the nibbler is configured to punch continuously the workpiece interposed between the case and the die with the punch while the nibbler moves in a prescribed direction. The fluid jetting device has a jet port from which the fluid is jetted and is configured to jet the fluid from the jet port in a direction in which the punch approaches the die. The jet port of the fluid jetting device is disposed near the blade of the punch.

Preferably, the jet port of at least one fluid jetting device is disposed to at least one of both sides in a direction orthogonal to the top-bottom direction and a direction in which the nibbler moves, relative to the blade of the punch.

A second aspect of the invention is a cutting method for cutting a sheet-like workpiece including a first step of preparing a nibbler that includes a cylindrical case, a punch that has a blade for punching the workpiece and that is housed in the case to reciprocate in a top-bottom direction, and a die provided below the case, a second step of preparing a fluid jetting device that jets a fluid onto a surface of the workpiece in a direction in which the punch approaches the die, and a third step of punching continuously the workpiece interposed between the case and the die in a prescribed direction with the punch while making the nibbler move in a prescribed direction. The fluid is jetted onto a part of the workpiece near the blade by the fluid jetting device in the third step.

### Advantageous Effects of Invention

The present invention makes it possible to suppress vibration of the workpiece at low cost and to cut a workpiece with high precision.

### BRIEF DESCRIPTION OF DRAWINGS

FIG. 1 shows a cutting apparatus according to an embodiment of the present invention.

FIG. 2(a) is a sectional view showing the cutting apparatus according to the embodiment of the present invention, and FIG. 2(b) is an end view taken along line A-A of FIG. 2(a).

FIG. 3 shows a position of a fluid jetting device of a first alternative embodiment of the cutting apparatus according to the present invention.

FIG. 4 shows the first alternative embodiment of the cutting apparatus according to the present invention.

FIG. 5 shows a shape of a fluid jetting device of a second alternative embodiment of the cutting apparatus according to the present invention.

### DESCRIPTION OF EMBODIMENTS

With reference to drawings, a cutting apparatus 1 as an embodiment of a cutting apparatus according to the present invention is described below.

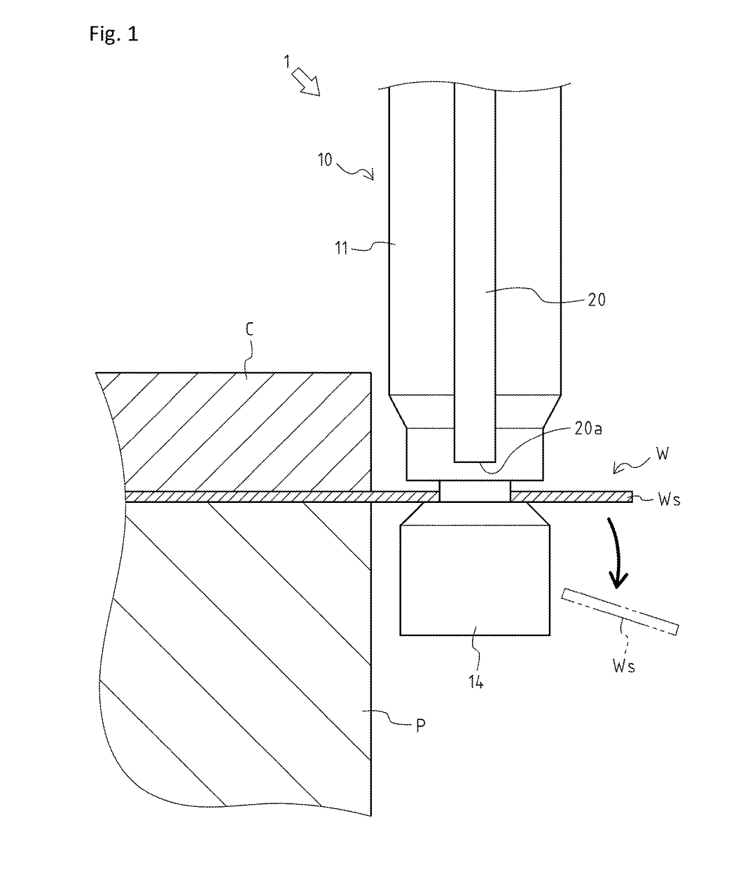

For convenience of explanation, the top-bottom direction in the FIG. 1 is defined as the top-bottom direction of the cutting apparatus 1.

As shown in FIG. 1, the cutting apparatus 1 cuts a workpiece W. The cutting apparatus 1 cuts the workpiece W to remove a scrap part Ws which is an unwanted part of the workpiece W. The cutting apparatus 1 may be configured to be griped by an operator to cut the workpiece W manually, or to be attached to a robot arm to cut the workpiece W automatically.

The workpiece W is a sheet (for example, a steel sheet) to be cut by the cutting apparatus 1. The workpiece W is placed on a placing table P. The workpiece W is disposed such that the scrap part Ws is not situated on the placing table P. A part of the workpiece W coming in contact with the placing table P is pressed toward the placing table P by a clamp C. That is, the workpiece W is fixed by clamping only a part to be the final product (herein after referred to as a “product part”) with the placing table P and the clamp C. Therefore, the scrap part Ws removed by the cutting apparatus 1 falls under weight thereof, and is discarded suitably.

The cutting apparatus 1 includes a nibbler 10 and a fluid jetting device 20.

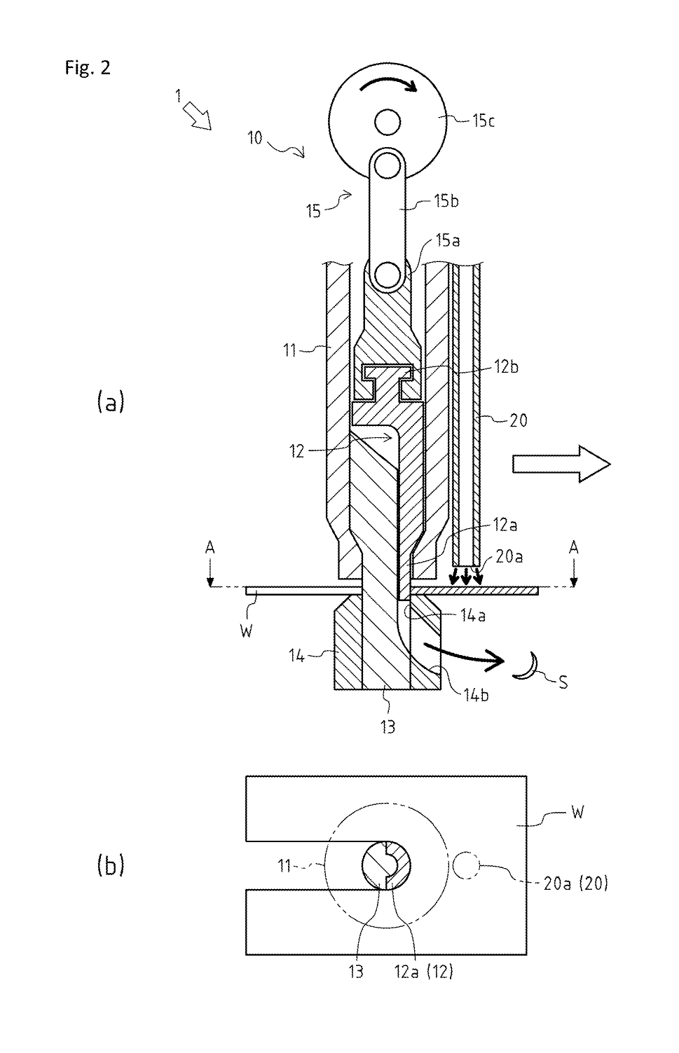

As shown in FIGS. 2(a) and 2(b), the nibbler 10 is a device moving in a prescribed direction while continuously punching the workpiece W, and includes a case 11, a punch 12, a supporting part 13, a die 14, a driving part 15.

Additionally, the horizontal white painted arrow in FIG. 2(a) shows the direction in which the nibbler 10 (exactly the cutting apparatus 1) moves.

The case 11 is formed in substantially a cylinder extending in the top-bottom direction, and the lower end part thereof is open.

The punch 12 is housed in the case 11 so as to slide in the top-bottom direction.

The supporting part 13 is fixed to the inner circumferential surface of the case 11, and supports the case 11 and the die 14.

The punch 12 reciprocates in the top-bottom direction at a predetermined frequency, and punches the workpiece W. The punch 12 has a blade 12a, and a connecting part 12b.

The blade 12a has a sectional shape of substantially a horseshoe, and the lower end thereof is formed as a blade edge for punching the workpiece W. The blade 12a protrudes downward from the lower end of the case 11 to enter an after-mentioned die hole 14a of the die 14 when the punch 12 arrives at the bottom dead center.

The connecting part 12b is connected to the driving part 15 so that the driving part 15 reciprocates the punch 12 in the top-bottom direction.

The supporting part 13 is a member which supports the case 11 and the die 14. The upper end part of the supporting part 13 is fixed to the inner circumferential surface of the case 11, and the supporting part 13 extends downward from the inside of the case 11. The supporting part 13 has such a shape that an opening coincident with the sectional shape of the blade 12a is formed on the lower end surface of the case 11. In other words, a space in which the punch 12 is housed is formed between the case 11 and a part of the supporting part 13 inserted into the case 11, and the opening of the space formed on the lower end surface of the case 11 has the shape coincident with the sectional shape of the blade 12a.

The die 14 is fixed to the lower end part of the supporting part 13.

The die 14 is arranged below the case 11 so as to be on the opposite side of the case 11 across the workpiece W. The die 14 is formed in substantially a cylinder. The die 14 is fixed to the supporting part 13 so as to cover the lower end part of the supporting part 13. The die 14 has the die hole 14a, and an ejecting hole 14b.

The die hole 14a is formed so that the blade 12a enter thereinto when the punch 12 arrives at the bottom dead center. Specifically, the die hole 14a is formed between the die 14 and a part of the supporting part 13 inserted into the die 14. The die hole 14a has the shape coincident with the sectional shape of the blade 12a, and opens on the upper end surface of the die 14.

The ejecting hole 14b is a hole through which a crescentic scrap S punched from the workpiece W by the punch 12 is ejected to the outside of the die 14. The ejecting hole 14b is formed on the lateral surface of the die 14, and communicates with the die hole 14a.

The driving part 15 reciprocates the punch 12 in the top-bottom direction at a predetermined frequency. The driving part 15 has a connecting part 15a, a rod 15b, and a motor 15c.

The connecting part 15a is connected to the connecting part 12b of the punch 12.

The rod 15b is connected to the motor 15c and the connecting part 15a so as to transmit power of the motor 15c to the connecting part 15a.

The motor 15c transmits power to the connecting part 15a through the rod 15b. Revolution of the motor 15c (see the arrow on the motor 15c in FIG. 2) is converted into vertical movement of the connecting part 15a through the rod 15b. [0023]

As mentioned above, the nibbler 10 makes the punch 12 reciprocate in the top-bottom direction (direction in which the punch 12 moves into and out of proximity with the die 14) while moving in a predetermined direction with the workpiece W interposed between the case 11 and the die 14, thereby continuously punching the workpiece W.

The fluid jetting device 20 is formed substantially in a tube extending in the top-bottom direction, and is configured to jet the fluid downward (toward the surface of the workpiece W) from a jet port 20a formed on the lower end thereof. The fluid jetting device 20 is controlled by a prescribed controller to jet the fluid at the predetermined pressure while the nibbler 10 is working the workpiece W. The fluid jetting device 20 is provided to keep a positional relationship to the nibbler 10. In the present embodiment, the fluid jetting device 20 is fixed on the outer circumferential surface of the case 11 of the nibbler 10, and the jet port 20a is situated at the side of the blade 12a.

Additionally, gas such as compressed air, and liquid such as water and cutting oil may be adapted as the fluid jetted from the fluid jetting device 20, but the compressed air is preferably adapted from the viewpoint of cost, work efficiency and the like.

As shown in FIG. 2(a), the fluid jetting device 20 is disposed such that the jet port 20a is situated near the surface of the workpiece W. In other words, the fluid jetting device 20 is disposed such that the jet port 20a is separated by a prescribed distance from the surface of the workpiece W, and is disposed to be able to jet the fluid at a short distance of the surface of the workpiece W.

As shown in FIG. 2(b), the fluid jetting device 20 is disposed such that the jet port 20a is situated near the blade 12a of the punch 12. In other words, the fluid jetting device 20 is disposed to jet the fluid onto the part of the workpiece W near the blade 12a. In the present embodiment, the jet port 20a of the fluid jetting device 20 is disposed away from the blade 12a in the direction in which the nibbler 10 is moved. For further details, the fluid jetting device 20 is disposed such that the jet port 20a is situated outward of the case 11 and is situated at a position away from the blade 12a in the direction in which the nibbler 10 is moved (the right direction in FIG. 2(b)).

As mentioned previously, in the workpiece W, only the product part is fixed by the placing table P and the clamp C, and a part to be cut off by the cutting apparatus 1 is not fixed (see FIG. 1).

Therefore, if the workpiece W is cut with only the nibbler 10, a part of the workpiece W corning in contact with the blade 12a is intermittently lifted up according to the reciprocating motion of the punch 12, and the workpiece W is vibrated.

However, the cutting apparatus 1 jets fluid at the predetermined pressure from above toward a part of the workpiece W which may be lifted up by the punch 12, that is, a part of the workpiece W near the blade 12a, by disposing the jet port 20a of the fluid jetting device 20 near the blade 12a of the punch 12.

Hereby, the force acts on the workpiece W against the direction in which the workpiece W is lifted up by the punch 12 by the fluid jetted through the jet port 20a, and therefore it is possible to suppress that the part of the workpiece W coming in contact with the blade 12a is lifted up intermittently by the reciprocating motion of the punch 12.

Accordingly, it is possible to suppress the vibration of the workpiece W, and therefore it is possible to cut the workpiece W with high precision and to suppress noise generated when the workpiece W crashes against the die 14.

Furthermore, it is possible to suppress vibration of the workpiece W without fixing the scrap part Ws and the like, and therefore it is possible to reduce cost for cutting the workpiece W.

Further, it is possible to suppress vibration of the workpiece W without making a change such that the shape of the workpiece W which is cut off by the nibbler 10 is limited, such as reducing distance between the case 11 and the die 14 as same level as the thickness (the vertical dimensions in FIG. 2(a)) of the workpiece W.

Further, it is possible to suppress vibration of the workpiece W by jetting the fluid on the surface of the workpiece W, and therefore it is possible to cut various shapes of workpieces.

Additionally, the pressure at which the fluid jetting device 20 jets the fluid is set to such a value that the workpiece W is not lifted up by the punch 12. The fluid is preferably jetted onto the part as near as possible to the blade 12a in the workpiece W to suppress vibration of the workpiece W at the pressure as low as possible.

A fluid jetting device may be configured to jet the fluid through a clearance between the case 11 and the blade 12a in order to jet the fluid onto the part extremely near the blade 12a in the workpiece W.

Further, the fluid jetting device 20 fixed on the case 11 of the nibbler 10, has only to move the nibbler 10 in order to jet the fluid along the moving locus of the nibbler 10, and therefore it is possible to suppress vibration of the workpiece W with a simple configuration.

In the present embodiment, one fluid jetting device 20 is provided, but the number of the fluid jetting device is not limited, and a plurality of the fluid jetting devices may be provided.

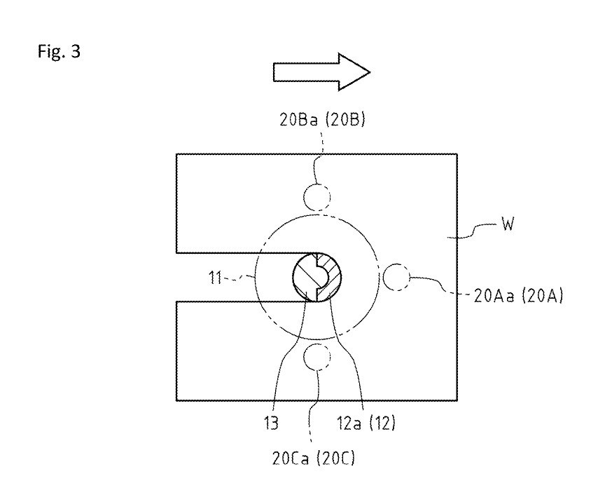

For example, as shown in FIG. 3, three fluid jetting devices 20A, 20B and 20C may be provided.

Each of the fluid jetting devices 20A, 20B and 20C is configured to jet the fluid onto the part of the workpiece W near the blade 12a as well as the fluid jetting device 20.

Additionally, the white painted arrow in FIG. 3 shows the direction in which the nibbler 10 (exactly the cutting apparatus 1) moves.

The fluid jetting device 20A is disposed as well as the fluid jetting devices 20. For further details, the fluid jetting device 20A is disposed such that a jet port 20Aa thereof is situated outward of the case 11 and in an advanced position from the blade 12a in the direction in which the nibbler 10 moves (the right direction in FIG. 3).

In the fluid jetting device 20B, a jet port 20Ba thereof is disposed to one side (the upper side in FIG. 3) of a direction orthogonal to the top-bottom direction and the direction in which the nibbler 10 moves, relative to the blade 12a. For further details, the fluid jetting devices 20B is disposed such that the jet port 20Ba thereof is situated outward of the case 11 and in advanced position from the blade 12a to one side (the upper direction in FIG. 3) of a direction orthogonal to the top-bottom direction and the direction in which the nibbler 10 moves.

In the fluid jetting device 20C, a jet port 20Ca thereof is disposed to the other side (the lower side in FIG. 3) of a direction orthogonal to the top-bottom direction and the direction in which the nibbler 10 moves, relative to the blade 12a. For further details, the fluid jetting devices 20B is disposed such that the jet port 20Ca thereof is situated outward of the case 11 and in an advanced position from the blade 12a to the other side (the lower direction in FIG. 3) of the direction orthogonal to the top-bottom direction and the direction in which the nibbler 10 moves.

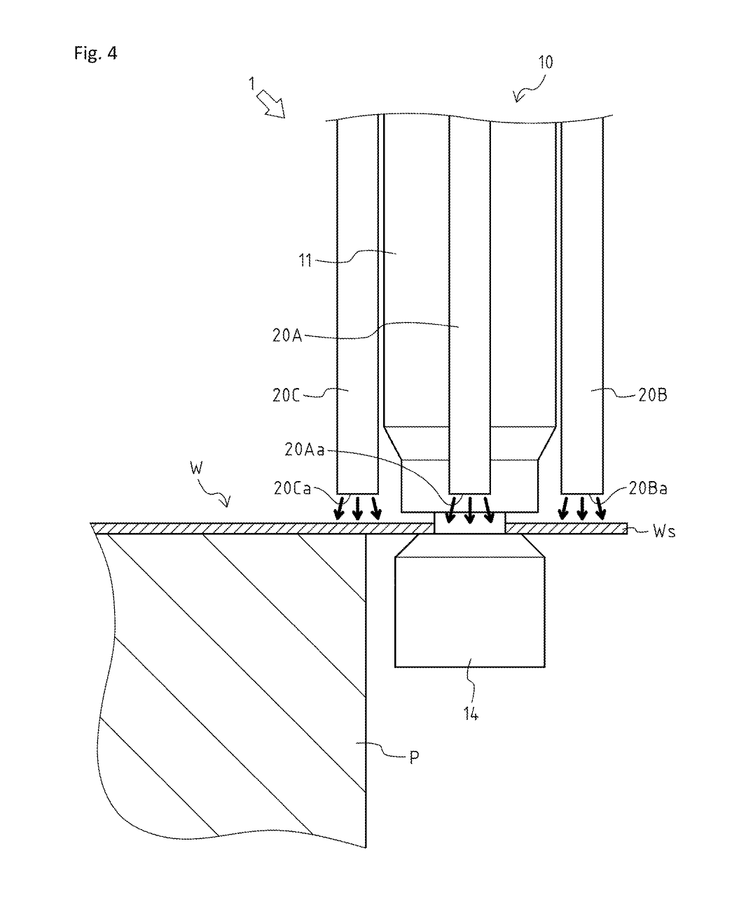

As shown in FIG. 4, if the fluid jetting devices 20B and 20C is provided in addition to the fluid jetting device 20A which is disposed as well as the fluid jetting devices 20, the fluid jetting device 20B jets the fluid onto the scrap part Ws of the workpiece W and the fluid jetting device 20C jets the fluid onto the product part of the workpiece W when the workpiece W is cut.

In this way, three fluid jetting devices 20A, 20B and 20C jet the fluid onto a plurality of positions around the blade 12a in the workpiece W, and therefore it is possible to further suppress vibration of the workpiece W.

In particular, the fluid jetting device 20B jet onto the scrap part Ws in which the vibration is easily generated without being fixed, and therefore it is possible to suppress vibration of the workpiece W effectively.

Furthermore, since the fluid jetting device 20C jets the fluid onto the product part of the workpiece W from above, the fluid press the product part of the workpiece W toward the placing table P.

Hereby, it is possible to fix the product part of the workpiece W without providing the clamp C for fixing the product part of the workpiece W.

Accordingly, it is possible to reduce the cost for cutting the workpiece W.

A fluid jetting device with a jet port which jets to the wide range near the blade 12a may be provided instead of providing a plurality of fluid jetting devices.

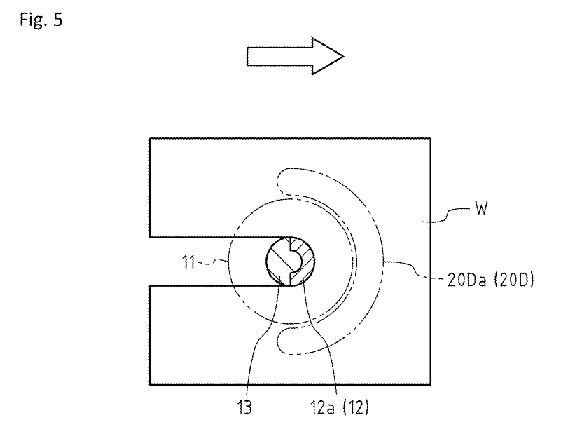

For example, as shown in FIG. 5, a fluid jetting device 20D may be provided which has an arc-shaped jet port 20Da along the outer circumference of the case 11.

The fluid jetting device 20D is shaped along the outer circumference of the case 11 in outward of the case 11 such that the jet port 20Da is situated from a place advanced from the blade 12a in the direction in which the nibbler 10 moves (the right direction in FIG. 3) to places advanced from the blade 12a to one side (the upper direction in FIG. 5) and the other side (the lower direction in FIG. 5) of the direction orthogonal to the top-bottom direction and the direction in which the nibbler 10 moves.

Herewith, one fluid jetting device 20D can act as well as the three fluid jetting devices 20A, 20B and 20C.

### INDUSTRIAL APPLICABILITY

The present invention is applicable to a cutting apparatus and cutting method for cutting a sheet-like workpiece.

### REFERENCE SIGNS LIST

1: cutting apparatus
10: nibbler
11: case
12: punch
12a: blade
14: die
20: fluid jetting device
20a: jet port
W: workpiece
Ws: scrap part

1. A cutting apparatus for cutting a sheet-like workpiece comprising:
a nibbler that continuously punches the workpiece; and
at least one fluid jetting device that jets a fluid onto a surface of the workpiece;
wherein the nibbler includes a cylindrical case, a punch that has a blade for punching the workpiece and that is housed in the case to reciprocate in a top-bottom direction, and a die provided below the case, and the nibbler is configured to punch continuously the workpiece interposed between the case and the die with the punch while the nibbler moves in a prescribed direction,
the fluid jetting device has a jet port from which the fluid is jetted and is configured to jet the fluid from the jet port in a direction in which the punch approaches the die, and
the jet port of the fluid jetting device is disposed near the blade of the punch.

2. The cutting apparatus according to claim 1, wherein
the jet port of at least one fluid jetting device is disposed to at least one of both sides in a direction orthogonal to the top-bottom direction and a direction in which the nibbler moves, relative to the blade of the punch.

3. A cutting method for cutting a sheet-like workpiece comprising:
a first step of preparing a nibbler that includes a cylindrical case, a punch that has a blade for punching the workpiece and that is housed in the case to reciprocate in a top-bottom direction, and a die provided below the case;
a second step of preparing a fluid jetting device that jets a fluid onto a surface of the workpiece in a direction in which the punch approaches the die; and
a third step of punching continuously the workpiece interposed between the case and the die in a prescribed direction with the punch while making the nibbler move in a prescribed direction,
wherein the fluid is jetted onto a part of the workpiece near the blade by the fluid jetting device in the third step.
